(19) United States
(12) Patent Application Publication
(10) Pub. No.: US 2022/0394981 A1
(43) Pub. Date: Dec. 15, 2022

(54) MICRONUTRIENT FORMULATIONS THAT CONTROL PLANT PATHOGENS

(71) Applicant: TradeMark Nitrogen Corp., Tampa, FL (US)

(72) Inventor: Robert C. Adair, JR., Vero Beach, FL (US)

(73) Assignee: TradeMark Nitrogen Corp., Tampa, FL (US)

(21) Appl. No.: 17/837,103

(22) Filed: Jun. 10, 2022

Related U.S. Application Data
(60) Provisional application No. 63/209,162, filed on Jun. 10, 2021.

(51) Int. Cl. A01N 59/16

(52) U.S. Cl. CPC A01N 59/16

(57) ABSTRACT

Disclosed are micronutrient chelate compositions and methods that provide nutrients to a plant to improve growth while controlling pathogens, such as Candidatus Liberibacter asiaticus the causal pathogen for citrus greening disease, by improving plant health through the enhancement of beneficial microbial populations resident in the plants phloem. The chelate compositions include a combination of a metal, such as iron, and a derivative of a chelating agent such as EDDHA or HBED. The chelate formulations can either be a dry formulation or liquid formulation that is dispersed in a selected amount of water and applied to the foliage of a plant and/or applied to the soil proximal to the plant rhizosphere.

### CROSS REFERENCE TO RELATED APPLICATION

This application claims priority to U.S. provisional patent application No. 63/209,162 filed Jun. 10, 2021, the entirety of which is incorporated herein by reference.

### TECHNICAL FIELD AND BACKGROUND

The present invention relates generally to compositions and methods for providing micronutrients to plans while treating plants using micronutrient chelate compositions that mitigate pathogens like Candidatus Liberibacter asiaticus (“CLas”) that cause citrus greening disease. Citrus greening disease, also known as Huanglongbing or HLB, is a serious disease that negatively impacts all cultivars of citrus and threatens the sustainability of citrus production worldwide. There is no known cure for HLB.

Plants with citrus greening disease and similar pathogens exhibit micronutrient deficiencies such as chlorosis (i.e., an abnormal loss of green coloration in leaves often caused by iron deficiency) as well as reduced activity in roots of Fe(III) reductase (i.e., an enzyme that promotes the chemical reduction of iron from Fe³⁺ to the more plant preferred Fe²⁺). The micronutrient deficiencies caused by citrus greening disease and similar pathogens results in a decline in plant health where plants will lose leaves and fruit, suffer root and branch dieback, and die prematurely. In citrus plants, HLB also causes smaller fruit size, fruit that remains green after ripening, and bitter-tasting fruit having little or no commercial value. Infected plants also have a diminished capacity to absorb nutrients from fertilizers that would otherwise mitigate the deleterious effects of micronutrient deficiencies.

To address the serious problems associated with micronutrient deficiencies in plants with citrus greening disease or similar pathogenic conditions, disclosed herein are formulations and methods that provide plants with critical micronutrients while also treating plant pathogens like CLas as an underlying cause of the citrus greening disease and micronutrient deficiencies.

### SUMMARY

Disclosed are micronutrient chelate compositions and methods that provide nutrients to plants to improve growth while controlling pathogens. A first composition includes a micronutrient chelate that can be at least one of either a derivative of Fe(III)HBED or a derivative of Fe(III)EDDHA, such as EDDHA, EDDHSA, EDDHMA, or EDDCHA, among others. When the micronutrient chelate is Fe(III)EDDHA, at least 90% of the Fe(III)EDDHA molecules should preferably be an ortho-ortho isomer. The first micronutrient chelate is present in the composition in an amount that is effective for treating the CLas bacterium. Effective amounts for treating CLas bacterium can be between 0.1 weight percent and 10 weight percent of iron (Fe) content on a weight basis. More specifically, effective amounts can be between 0.5 weight percent and 6 weight percent of iron (Fe) content on a weight basis.

The micronutrient chelate composition can also include a second micronutrient chelate that is selected from one or more of (i) Mn-DTPA present in an amount between 0.01 weight percent and 10 weight percent of the manganese (Mn) content on a weight basis, (ii) Zn-IDHA present in an amount between 0.01 weight percent and 10 weight percent of the zinc (Zn) content on a weight basis, or (iii) Mn-EDTA present in an amount between 0.01 weight percent and 10 weight percent of the manganese (Mn) content on a weight basis. In both cases, the micronutrient chelates can be provided as a dry solid that is later mixed with one or more solvents before being applied to a plant foliage or the surrounding soil.

In another embodiment, a micronutrient chelate composition includes a micronutrient chelate in a solvent. The micronutrient chelate is made of a chelating agent selected from one or more of IDHA, EDTA, DTPA, EDDHA or HBED. The chelating agent is bonded to a metal cation to form the micronutrient chelate. The metal cation can be selected from Fe2+, Fe3+, Zn2+, Cu2+, or Mn2+. Generally, the micronutrient chelate is present in the solvent in the range between 0.1 weight percent and 4 weight percent of the micronutrient chelate. Suitable solvents can include water. In yet other embodiments, the micronutrient chelate composition includes an anionic surfactant present in the range of between 0.1 weight percent and 1.0 weight percent.

Also disclosed are methods for controlling plant pathogens and providing micronutrients to a plant. The first step is to prepare a micronutrient composition, such as those described above, by combining and then mixing one or more micronutrient chelates in a dry granule or powder form with a solvent, such as water. The micronutrient chelate composition is then applied to a plant foliage and/or the soil surrounding a plant that is proximal to the rhizosphere. The application can be repeated periodically, such as once a month, to observe improvement to the overall plant health.

### DETAILED DESCRIPTION

The present invention will now be described more fully hereinafter with reference to the accompanying pictures in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention. Although the following description provides embodiments of the invention by way of example, it is envisioned that other embodiments may perform similar functions and/or achieve similar results. Any and all such equivalent embodiments and examples are within the scope of the present invention.

Relative terms such as lower or bottom; upper or top; upward, outward, or downward; forward or backward; and vertical or horizontal may be used herein to describe one element's relationship to another element illustrated in the figures. It will be understood that relative terms are intended to encompass different orientations in addition to the orientation depicted in the drawings. Relative terminology, such as “substantially” or “about,” describe the specified materials, steps, parameters, or ranges as well as those that do not materially affect the basic and novel characteristics of the claimed inventions as whole (as would be appreciated by one of ordinary skill in the art).

The disclosed micronutrient chelate formulations and methods are capable of both delivering critical micronutrients to plants and also effectively treating plant pathogens. Preferred chelating agents include derivatives of ethylenediamine-N,N′-bis(2-hydroxyphenyl acetic acid) (“EDDHA”) and N,N′-bis(2-hydroxyphenyl)ethylenediamine-N,N′-diacetic acid (“HBED”). The preferred chelating agents are bonded with an iron cation (preferably Fe³⁺ or “Fe(III)”) to form the micronutrient chelates Fe(III)EDDHA or Fe(III)HBED. The micronutrient chelates can be conveniently mixed under field conditions with water and optionally further mixed with a surfactant and one or more additional micronutrient chelates such as manganese diethylenetriaminepentaacetic acid (“Mn-DTPA”) or Zinc imidodisuccinic acid (“Zn-IDHA”). The resulting formulation can be placed into a tank or other receptacle and sprayed or otherwise applied to the foliage of a plant or the soil surrounding the roots.

Many micronutrients such as iron (Fe), manganese (Mn), and Zinc (Zn) are cations and, as such, are commonly found in salt form where the micronutrient is positively charged and largely unavailable to plants. The disclosed chelating agents surround the micronutrients to neutralize the positive charge and allow the micronutrient to enter pores on plant surfaces and travel through a plant. The plant removes the micronutrient from the chelating agent and passes the chelate back into solution in the surrounding soil.

Some chelating agents completely surround, or encapsulate, the micronutrient while other chelating agents only partially surround the micronutrient to form a complex. Additionally, different chelating agents may have a varying number of connection points (i.e., ligands) to the micronutrient and, therefore, form stronger or weaker bonds with a micronutrient. Depending on the particular application and environment (i.e., temperature, soil type, pH level), a chelating agent may bond to a micronutrient too strongly or not strong enough.

The strength of the bond between a chelating agent and a micronutrient can be characterized by a stability constant (e.g., a “formation constant” or “binding constant”), which is an equilibrium constant for the formation of a complex in solution. The micronutrient chelates derivatives of Fe(III)EDDHA and Fe(III)HBED have superior stability constants over other chelate compounds and form stable bonds between iron and the EDDHA and HBED derivatives. By way of example, Fe(III)EDDHA has a stability constant of 35.40, and Fe(III)HBED has a stability constant of 39, as compared to iron citrate (Fe²⁺) that has a significantly lower stability constant of only 3.2. For reference, stability constants for selected metal chelates is shown in the chart below. See Arthur E. Martell & Robert M. Smith, Critical Stability Constants (1982) (ISBN 978-1-4615-6761-5).

Stability Constants (K) of Selected Metal Chelates

| Chelating | LogK | | | | | |
|---|---|---|---|---|---|---|
| Agent | Fe2+ | Fe3+ | Zn2+ | Cu2+ | Mn2+ | Ca2+ |
| IDHA | | 15.2 | 10.8 | 13.1 | 7.7 | |
| HEEDTA | 12.2 | 19.6 | 14.5 | 17.4 | 10.7 | 8.0 |
| HEDTA | 12.2 | 19.7 | 14.6 | 17.4 | 11.1 | 8.1 |
| EDTA | 14.3 | 25.1 | 16.5 | 18.8 | 13.6 | 10.7 |
| DTPA | 16.5 | 28.6 | 18.3 | 21.1 | 15.1 | 10.7 |
| EDDHA | 14.3 | 35.0 | 16.8 | 23.9 | — | 7.2 |
| HBED | 17.3 | 39.0 | 18.3 | 21.4 | 16.5 | 9.3 |
| Complexes | | | | | | |
| Citrate | 3.2 | 11.85 | 4.9 | 5.9 | 3.7 | 4.7 |
| Gluconate | 1.0 | 10.0 | 1.7? | 36.0 | — | 1.2 |
| Saccharate | — | 24.5 | — | 14.0 | 8.5 | — |

The chelating agents EDDHA and HBED and their derivatives are considered superior fertilizer components in part because of the stable bonds formed with ferric complexes in both neutral and alkaline solutions. This allows the micronutrient chelates Fe(III)EDDHA and Fe(III)HBED to remain soluble in soil even with other anionic components, such as phosphate that renders metal cations insoluble and not available to the plant's roots and in turn ensures that plants receive proper micronutrients.

In addition to delivering micronutrients, Fe(III)EDDHA and Fe(III)HBED derivatives also treat plant pathogens known to cause micronutrient deficiencies, such as citrus greening disease. Citrus greening disease is believed to be caused by the CLas bacterium. CLas is a fastidious, gram-negative bacterium that resides in the phloem of a plant, which is part of a plant's vascular system. CLas is rapidly spread by the insect Asian citrus psyllid that is prevalent in citrus-growing regions like Florida. Conventional treatment strategies for CLas include combinations of insecticides, antibiotics, and thermotherapy, and these strategies have not been able to effectively control citrus greening disease. Thus far, all antimicrobial compounds applied by conventional and regulatory approved application methods, including canopy sprays or soil drenches, that have been tested have not been able to enter the phloem and control CLas bacteria or to effectively address micronutrient deficiencies caused by citrus greening disease. Overall, conventional treatment strategies have not demonstrated long-term effectiveness at treating pathogens such as CLas, and in particular, have not proven effective at treating citrus greening disease infected citrus trees.

The inventive micronutrient chelate formulations and methods disclosed in this application ameliorate the shortcomings of conventional treatment strategies by providing plants with critical micronutrients that promote plant growth while also treating the underlying pathogen. Experimental data has demonstrated that the present micronutrient chelate formulations successfully reduce CLas bacterium in the plant phloem where existing treatment strategies have not been successful. The inventive micronutrient chelate formulations applied to HLB infected citrus performs by improving the plant health and enhancing plant growth by providing micronutrients, especially iron.

The disclosed micronutrient chelate formulations treat pathogens by reducing the titer of CLas bacteria in the phloem and increasing the availability of iron for use in the plant's metabolic pathways, which enhances cellular function. As plant cellular function is enhanced, photosynthesis supplies additional carbohydrates to facilitate the production of plant tissue, such as leaves, roots, fruit and other plant parts. At the same time the chelates are providing iron to the plant's cells, excess chelate accumulates in the phloem and sequesters iron in the phloem that renders less iron available for the for the CLas bacteria to survive. This occurs in part because the stability constants (a measure of the strength of the chelate to acquire and hold a metal cation) of Fe(III)EDDHA and Fe(III)HBED are greater than the solubility constant of the siderophores (iron affinity chelates) produced by the CLas but less than the uptake affinity of the plant metabolic pathways that utilize iron. That is, iron in the phloem forms a more stable compound with the micronutrient chelates than with the siderophores used by the bacteria to capture iron, and as a result, the population of bacteria is reduced.

The micronutrient chelate formulations also treat pathogens by supplying iron to beneficial endophytes present in the phloem, such as endophytic bacteria, which in turn reduces iron available to pathogens. Endophytic bacteria can have beneficial effects on a host plant that include stimulation of plant growth, increased micronutrient solubilization, nitrogen fixation, production of antimicrobial compounds, siderophore production, and induction of resistance to plant pathogens. In particular, certain endophytic bacteria can be capable of solubilizing zinc, which protects plants from zinc toxicity (i.e., promotes plant health) and reduces the availability of zinc to pathogens that require zinc to survive, thereby enhancing plant health while treating pathogens. The endophytes can also lead to the production of antimicrobial compounds that treat pathogens, such as Streptomyces, an endophyte that produces streptomycin, a well-known antibiotic.

Micronutrient chelate formulations can include one of the following ferric chelate compounds combined with water:
Fe(III)EDDHA, CAS #16455-61-1, molecular weight 435.2, effective pH range of 4.0-9.0, where the Fe(III)EDDHA is present in an amount between 0.3% to 6% by weight percentage of iron content;
or
Fe(III)HBED, CAS #35369-530, molecular weight 424.89, effective pH range of 4.0-12.0, where the Fe(III)EDDHA is present in an amount between 0.3% to 6% by weight percentage of iron content.

The ferric micronutrient chelates and water are optionally combined with a surfactant such as:
Calfax® DB-45 from Pilot Chemical Company® (45% active aqueous solution of sodium branched dodecyl diphenyl oxide disulfonate);
DowFax® 8390 from Dow® chemical company (Alkyldiphenyloxide Disulfonate);
TEGITOL™ W-160 Wetting Agent from Dow® chemical company; or
Dow® TEGITOL™ XD (Ethylene Oxide/Propylene Oxide Block Copolymers)

In other embodiments, the ferric micronutrient chelates are optionally combined with one or more additional micronutrient chelates, such as:
Mn-DTPA (diethylenetriamine pentaacetate), and/or
Mn-EDTA (ethylenetriamine pentaacetate), and/or
Zn-IDHA (imidodisuccinic acid).

An example micronutrient chelate liquid formulation for fertilizing citrus plants and treating citrus greening disease is as follows:
Fe(III)EDDHA or Fe(III)HBED present in an amount between 0.5% to 6% by weight percentage of iron content;
Anionic surfactant present in an amount between 0.1% to 1% by weight percentage;
Mn-DTPA present in an amount between 0.1% to 0.5% by weight percentage of manganese content;
Zn-IDHA present in an amount between 0.05% to 0.25% by weight percentage of zinc content; and
Water.

An example micronutrient chelate formulation for fertilizing citrus plants and treating citrus greening disease is as follows:
Fe(III)EDDHA or Fe(III)HBED present in an amount between 0.5% to 6% by weight percentage of iron content;
Anionic surfactant present in an amount between 0.5% to 4% by weight percentage;
Mn-DTPA present in an amount between 0.1% to 4% by weight percentage of manganese content; and
Zn-IDHA present in an amount between 0.05% to 2% by weight percentage of zinc content.

Formulations using Fe(III)EDDHA should be made of at least 90% of the ortho-ortho isomer of Fe(III)EDDHA. The Fe(III)EDDHA micronutrient chelate can present as different positional isomers, such as: (i) the ortho-ortho (o,o) isomer; (ii) the ortho-para (o,p) isomer; and (iii) the para-para (p,p) isomer. Of these isomers, the (p,p) isomer cannot chelate with iron in soil solution under a wide range of pH values, but both the (o,o) and (o,p) isomers are able to chelate under a wider range of soil pH values.

The micronutrient chelates formulations may effectively utilize derivatives of EDDHA, such as
EDDHA (ethylenediaminedi (o-hydroxyphenyl)acetic acid);
EDDHSA (ethylenediaminedi (2-hydroxy-5-sulfophenyl)acetic acid);
EDDHMA (ethylenediaminedi (0-hydroxy-p-methylphenyl)acetic acid);
EDDCHA (ethylenediaminedi (5-carboxy-2-hydroxyphenyl)acetic acid);
ethylenediaminedi (2-hydroxy-5-phosphophenyl)acetic acid;
ethylenediaminedi (2-hydroxy-5-t-butylphenyl)acetic acid;
ethylenediaminedi (2-hydroxy-3-methylphenyl)acetic acid;
ethylenediaminedi (2-hydroxy-4-methylphenyl)acetic acid;
ethylenediaminedi (2-hydroxy-3,5-dimethylphenyl)acetic acid;
ethylenediaminedi (2-hydroxy-4,6-dimethylphenyl)acetic acid; or
ethylenediaminedi (2-hydroxy-3,5-dichlorophenyl)acetic acid.

The embodiments described in this disclosure and the experimental testing was conducted on citrus plants known to be symptomatic with citrus greening disease. However, those of skill in the art will recognize that the micronutrient chelates formulations and accompanying methods could also be utilized to treat pathogens similar to CLas, such as the Candidatus Liberibacter solanacearum that is known to infect potato plants causing zebra chip disease.

### Experimental Results, Materials, and Methods

Experimental testing was performed at the Florida Research Center for Agricultural Sustainability (“FLARES”) in Vero Beach, Fla. where the inventor, Robert C. Adair, Jr. serves as the executive director after having founded FLARES in 2004. Testing was conducted on a uniform block of ninety-six (96) Ruby red grapefruit trees planted on Dec. 19, 2018 grafted with USDA “US-897” citrus rootstock. The red grapefruit trees were randomly assigned one of eight (8) treatments in twelve (12) replicated plots using a Randomized Complete Block (“RCB”) design to help ensure homogeneous conditions between test subject trees. The red grapefruit trees were treated using liquid formulations applied to the foliage, the soil proximal to the rhizosphere of the plant, or applied to both the foliage and the soil. The micronutrient chelate formulations were applied monthly, the citric acid treatments were applied weekly, and the iron nitrate treatment was applied every two weeks.

Before being treated, the red grapefruit trees were allowed time to establish root systems. The red grapefruit trees were exposed to infection of the CLas bacteria through native populations of the Asian citrus psyllid insect, which is the vector that spreads citrus greening disease among trees. The caliper, canopy diameter, and height for each grapefruit tree was measured prior to treatment and subsequently measured every six (6) to nine (9) months thereafter for the two-and-half (2.5) year duration of the experiment.

Canopy areas were determined from aerial images captured by a camera-equipped unmanned aerial vehicle (“UAV”). The captured images were processed by algorithms developed to determine various size and shape measurements, including the two-dimensional canopy area. The method of image analysis employed for the experiment yielded precise measurements in red grapefruit tree growth for each of the eight (8) treatments based on increases in canopy area.

Tree condition was scored visually according to the disease indexing (“DI”) technique taught by Gottwald, Aubert, and Xue-Yuan. See Gottwald, T. R., B. Aubert, and Z. Xue-Yuan, Preliminary Analysis of Citrus Greening (Huanglungbin) Epidemics in the People's Republic of China and French Reunion Island, PHYTOPATHOLOGY Vol. No. 79: 687-693 (1989). Disease indexing techniques divide an image of a plant into multiple sections and/or subsections, such as hemispheres and quadrants, and assign each image section a score from zero to four. The score reflects the observable severity of disease impact on a plant with a score of four indicating a plant with no visible symptoms and a score of zero indicating the highest level of severity. The score for all sections of a plant image are added together to establish an overall DI score for a particular plant image, such that a healthy vigorous tree with no symptoms has a DI of 16.

DI scores can be compared across images taken at different times to ascertain the increasing or decreasing severity of disease impact on a plant. Disease indexing techniques are useful for evaluating the impact of HLB on a plant because HLB symptoms are not evenly distributed over the canopy of an infected plant. Thus, DI techniques normalize the varying impact of HLB disease on different portions of a plant.

Individual leaf samples were collected from each of the ninety-six (96) trees and submitted to Southern Gardens Diagnostic Laboratory in Clewiston, Fla. for Polymerase Chain Reaction (“PCR”) analysis to determine the presence of CLas bacteria DNA. The results were expressed cycle threshold (“Ct”) values, and the logarithm of the copy number per milligram of tissue values were recorded and statistically evaluated. In a PCR analysis, a positive reaction is detected by the accumulation of a fluorescent signal. The Ct value is defined as the number of cycles required for a fluorescent signal to cross a threshold (i.e., exceeds background levels). Ct values are inversely proportional to the amount of a target nucleic acid in the sample being tested such that the lower the Ct level, the greater the amount of target nucleic acid in the sample. Ct values less than 29 are considered strong positive reactions indicative of an abundance of the target nucleic acid, and Ct values of 38-40 are indicative of minimal amounts of target nucleic acid.

Table 1 below provides details relating to each of the eight (8) treatment methods used during the experiment, including the formulation used and the application method. Overall, the experimental results showed that both foliar and soil application of Fe(III)HBED or Fe(III)EDDHA increased tree growth versus an untreated control. More importantly, it was observed that the same applications of Fe(III)HBED or Fe(III)EDDHA also reduced the symptoms of citrus greening disease both visually and analytically based on a reduction in CLas bacteria determined by PCR analysis. Further testing based on visual inspection showed that citrus greening disease leaf symptoms were also reduced by Fe(III)HBED or Fe(III)EDDHA applications to the infected grapefruit trees.

TABLE 1

| | | Amount of | Amount of | Spray | Drench |
|---|---|---|---|---|---|
| | | Material/20 | Material/ | Vol- | Vol- |
| | Appli- | gal for | 20 gal | ume | ume |
| | cation | Foliar | for Soil | per | per |
| Treatment Name | Method | Spray | Drench | Tree | Tree |
| Iron Citrate at 30 ppm Fe | Foliar | 908 ml | N/A | 1 qt | |
| Iron Citrate at 60 ppm Fe | Foliar | 151 ml | N/A | 1 qt | |
| Tracite 5% Iron | Foliar | 182 ml | N/A | 1qt | |
| Fe-IDHA (9% Fe) & | Foliar and Soil | 182 ml | 999 gm | 1 qt 1 qt | 1 gal |
| Fe HBED (7% Fe) | | | | | |
| Fe-EDDHA (6% Fe) | Foliar and | 272 ml | 1,165 gm | 1 qt | 1 gal |
| Fe-EDDHA (6% Fe) | Soil | | | 1 qt | |
| Ferrous Sulfate | Foliar and | 379 ml | 1,044 gm | 1 qt | 1 gal |
| & Citric Acid | Soil | | | | |
| Iron Nitrate | Foliar and | 40 ml | 522 gm | 1 qt | 1 gal |
| Solution | Soil | | | | |
| (9.5% Fe) | | | | | |
| Untreated Control | N/A | | | N/A | N/A |

Table 2 below shows results of the PCR analysis as measured by Ct values. Notably, the Fe(III)HBED and Fe(III)EDDHA micronutrient chelate applications showed the highest Ct values, and, therefore, the least amount of nucleic acids from the CLas bacteria indicating a lower titer of CLas. Similarly, Table 3 shows that the Fe(III)HBED and Fe(III)EDDHA micronutrient chelate applications demonstrated the highest percentage red grapefruit trees without the presence of CLas bacteria as indicated by a Ct value of 40. When the CLas titer is expressed as the logarithm of the Ct value per milligram of tissue, both chelated treatments exhibited the lowest values with the preferred treatment Fe(III)EDDHA being the lowest, as shown in Table 4.

TABLE 2

| | Average Ct values | | |
|---|---|---|---|
| | based on qPCR analysis | ± Std. | ± Std. |
| Treatments | of citrus leaves | Deviation | Error |
| Iron Citrate at 30 ppm Fe | 29.7 | 1.73 | 0.52 |
| Iron Citrate at 60 ppm Fe | 31.2 | 3.02 | 0.86 |
| Tracite 5% Iron | 30.4 | 3.64 | 1.15 |
| Fe-IDHA & Fe HBED | 34.1 | 5.26 | 1.64 |
| Fe-EDDHA | 34.9 | 5.09 | 1.54 |
| Ferrous Sulfate & Citric Acid | 33.9 | 4.29 | 1.29 |
| Iron Nitrate Solution | 32.3 | 4.91 | 1.48 |
| Untreated Control | 32.5 | 4.13 | 1.31 |

TABLE 3

| | % of PCR Analysis |
|---|---|
| Treatments | Showing No CLas (Ct values = 40) |
| Iron Citrate at 30 ppm Fe | 0% |
| Iron Citrate at 60 ppm Fe | 0% |
| Tracite 5% Iron | 8% |
| Fe-IDHA & Fe HBED | 42% |
| Fe-EDDHA | 50% |
| Ferrous Sulfate + Citric Acid | 33% |
| Iron Nitrate Solution | 25% |
| Untreated Control | 17% |

TABLE 4

| | Log Copy #/1 mg | | |
|---|---|---|---|
| Treatment | of Leaf Tissue | ± S.D. | ± S.E. |
| Iron Citrate at 30 ppm Fe | 2.6 | 0.52 | 0.16 |
| Iron Citrate at 60 ppm Fe | 2.1 | 0.91 | 0.27 |
| Tracite 5% Iron | 2.4 | 0.98 | 0.29 |
| Fe-IDHA + Fe HBED | 1.5 | 1.39 | 0.42 |
| Fe-EDDHA | 1.2 | 1.36 | 0.41 |
| Ferrous Sulfate + Citric Acid | 1.4 | 1.10 | 0.33 |
| Iron Solution | 1.9 | 1.26 | 0.38 |
| Untreated Control | 1.8 | 1.06 | 0.32 |

Table 5 below presents data from the visual inspection of the red grapefruit trees for the symptoms of citrus greening disease measured at 270 days after the first treatment application or approximately half way through the experiment. At that juncture, the red grapefruit trees treated with the Fe(III)EDDHA micronutrient chelate exhibited the lowest percentage of observable symptoms.

TABLE 5

| | Percentage of Trees | | |
|---|---|---|---|
| | Showing HLB Leaf | ± Std. | ± Std. |
| Treatments | Patterns | Deviation | Error |
| Iron Citrate at 30 ppm Fe | 44% | 0.53 | 0.18 |
| Iron Citrate at 60 ppm Fe | 50% | 0.52 | 0.15 |
| Tracite 5% Iron | 42% | 0.51 | 0.15 |
| Fe-IDHA & Fe HBED | 73% | 0.47 | 0.12 |
| Fe-EDDHA | 10% | 0.32 | 0.10 |
| Ferrous Sulfate + Citric Acid | 64% | 0.50 | 0.15 |
| Iron Nitrate Solution | 91% | 0.30 | 0.09 |
| Untreated Control | 64% | 0.50 | 0.15 |

A second trial was conducted in a commercial citrus grove in the Orange Ave. Citrus Growers Association located west of Ft. Pierce, Fla. The grove site selected consisted of three uniform blocks of approximately 16 acres each which were replanted in 2012 with Rio Red Grapefruit grafted on Sour Orange rootstock and were assigned to receive one of three treatments, Fe HBED, Fe-EDDHA, and an untreated control (“UTC”) via injection through the irrigation system. Each block was plumbed with a separate irrigation zone whereby it could be treated individually with the one of the treatments. Each block was treated twice with a first treatment administered on Oct. 25, 2021 and a second treatment on Feb. 9, 2022. Treatment rates are shown below in Table 6 illustrating the number of trees treated and the amount of micronutrient treatment applied per acre and per tree.

TABLE 6

| Block | | Block | Rate/ | Trees/ | lbs./ | lbs. |
|---|---|---|---|---|---|---|
| # | Treatments | Size (Ac) | Tree | Acre | Acre | Fe/Acre |
| 6 | Untreated Control | 17.4 | 0 | 150 | 0 | 0 |
| 5 | Fe EDDHA + Mn Chelate | 15.6 | 0.128 | 150 | 18.56 | 1.11 |
| | (10%) | | | | | |
| 4 | Fe HBED + Mn Chelate | 15.6 | 0.110 | 150 | 15.95 | 1.04 |
| | (10%) | | | | | |

To determine an accurate tree count of similarly healthy trees, the three blocks were flown with a drone equipped with a digital camera capable of producing high resolution images that were used to count the trees in each block and determine the tree health using normalized difference vegetation index (“NDVI”) imagery, software and machine learning provided by Areobotics, Cape Town, South Africa. NDVI is an indicator of vegetation health based on how plants reflect certain ranges of the electromagnetic spectrum. NDVI ranges from negative one (−1) to positive (+1) with regions of healthier plants with dense, green leaves having a NDVI closer to positive 1. The tree counts were based on the number of trees exhibiting a NDVI from 0.65 to 0.85 via a drone imagery taken on 10/12/2021.

The three blocks were individually harvested by a picking crew instructed to pick each block separately. The blocks were all picked on Mar. 8 to Mar. 28, 2022. Table 7 below presents the crop yield data from the three block clearly showing a marked increase in yield for the trees receiving the chelated iron treatments relative to the untreated control block, thereby validating the benefit of the composition based on an increase in crop yield.

TABLE 7

| | 2022 | % Increase over |
|---|---|---|
| Treatment | Boxes/Tree* | UTC |
| Untreated Control (UTC) | 2.12 | |
| Fe HBED + Mn Chelate (10%) | 2.33 | 9.9% |
| Fe EDDHA + Mn Chelate (10%) | 2.62 | 23.8% |

*Based on the no. of trees with a NDVI from 0.65 to 0.85 via a drone flown on Oct. 12, 2021.

What is claimed is:

1. A micronutrient chelate composition comprising:
(a) a first micronutrient chelate, wherein
(i) the first micronutrient chelate is selected from at least one derivative of either Fe(III)HBED or Fe(III)EDDHA, and
(ii) the first micronutrient chelate is present in an effective amount capable of treating the CLas bacterium; and
(b) an additional micronutrient chelate selected from one or more of (i) Mn-DTPA present in an amount between 0.01 weight percent and 10 weight percent of manganese (Mn) content on a weight basis, (ii) Zn-IDHA present in an amount between 0.01 weight percent and 10 weight percent of zinc (Zn) content on a weight basis, or (iii) Mn-EDTA present in an amount between 0.01 weight percent and 10 weight percent of manganese (Mn) content on a weight basis.

2. The micronutrient chelate composition of claim 1, wherein the first micronutrient chelate comprises at least one derivative of Fe(III)EDDHA selected from one or more of
(a) EDDHA ethylenediaminedi (o-hydroxyphenyl)acetic acid,
(b) EDDHSA ethylenediaminedi (2-hydroxy-5-sulfophenyl)acetic acid,
(c) EDDHMA ethylenediaminedi (O-hydroxy-p-methylphenyl)acetic acid,
(d) EDDCHA ethylenediaminedi (5-carboxy-2-hydroxyphenyl)acetic acid,
(e) ethylenediaminedi (2-hydroxy-5-phosphophenyl)acetic acid,
(f) ethylenediaminedi (2-hydroxy-5-t-butylphenyl)acetic acid,
(g) ethylenediaminedi (2-hydroxy-3-methylphenyl)acetic acid,
(h) ethylenediaminedi (2-hydroxy-4-methylphenyl)acetic acid,
(i) ethylenediaminedi (2-hydroxy-3,5-dimethylphenyl)acetic acid,
(j) ethylenediaminedi (2-hydroxy-4,6-dimethylphenyl)acetic acid, or
(k) ethylenediaminedi (2-hydroxy-3,5-dichlorophenyl)acetic acid.

3. The micronutrient chelate composition of claim 2, wherein at least 90% of the molecules for the at least one Fe(III)EDDHA derivative comprise an ortho-ortho isomer.

4. The micronutrient chelate composition of claim 3, wherein the effective amount comprises a range of between 0.1 weight percent and 10 weight percent of iron (Fe) content on a weight basis.

5. The micronutrient chelate composition of claim 1, wherein the effective amount comprises a range of between 0.5 weight percent and 6 weight percent of iron (Fe) content on a weight basis.

6. A micronutrient chelate composition comprising a micronutrient chelate in a solvent, wherein:
(a) the micronutrient chelate comprises a chelating agent selected from one or more of IDHA, EDTA, DTPA, EDDHA or HBED;
(b) the chelating agent is bonded to a metal cation to form the micronutrient chelate, wherein the metal cation is selected from Fe2+, Fe3+, Zn2+, Cu2+, or Mn2+;
(c) the micronutrient chelate is present in the solvent in the range between 0.1 weight percent and 4 weight percent of the micronutrient chelate; and wherein
(d) the solvent comprises water.

7. The micronutrient chelate composition of claim 6 further comprising an anionic surfactant present in the range of between 0.1 weight percent and 1.0 weight percent.

8. The micronutrient chelate composition of claim 7 further comprising a second micronutrient chelate selected from one or more of Mn-DTPA, Zn-IDHA, or Mn-EDTA.

9. The micronutrient chelate composition of claim 8, wherein the second micronutrient chelate comprises Mn-DTPA present in the range of between 0.1 weight percent and 0.5 weight percent of manganese (Mn) content on a weight basis.

10. The micronutrient chelate composition of claim 8, wherein the second micronutrient chelate comprises Zn-IDHA present in the range of between 0.05 weight percent and 0.25 weight percent of the zinc (Zn) content on a weight basis.

11. The micronutrient chelate composition of claim 6, wherein the micronutrient chelate comprises Fe(III)EDDHA.

12. The micronutrient chelate composition of claim 11, wherein at least 90% of the Fe(III)EDDHA molecules comprise an ortho-ortho isomer.

13. The micronutrient chelate composition of claim 6, wherein the micronutrient chelate comprises Fe(III)HBED.

14. A method for controlling plant pathogens and providing micronutrients to a plant comprising the steps of:
(a) preparing the micronutrient chelate composition of claim 6; and
(b) applying the micronutrient chelate composition to a location selected from one or more of a plant foliage or soil proximal to a plant rhizosphere.

15. The method for controlling plant pathogens and providing micronutrients to a plant of claim 14, wherein the micronutrient chelate composition comprises the micronutrient chelate Fe(III)EDDHA.

16. The method for controlling plant pathogens and providing micronutrients to a plant of claim 14, wherein the micronutrient chelate composition comprises the micronutrient chelate Fe(III)HBED.

17. The method for controlling plant pathogens and providing micronutrients to a plant of claim 15, wherein the micronutrient chelate composition further comprises a second micronutrient chelate selected from one or more of Mn-DTPA, Zn-IDHA, or Mn-EDTA

18. The method for controlling plant pathogens and providing micronutrients to a plant of claim 14, wherein the step of applying the micronutrient chelate composition to a location comprises the step of spraying at least one quart of the micronutrient chelate composition to the plant foliage at least once every thirty days for a period of at least ninety days.

19. The method for controlling plant pathogens and providing micronutrients to a plant of claim 14, wherein the step of applying the micronutrient chelate composition to a location comprises the step of pouring at least one gallon of the micronutrient chelate composition on the soil proximal to the plant rhizosphere at least once every thirty days for a period of at least ninety days.
